(19) United States
(12) Patent Application Publication
(10) Pub. No.: US 2025/0182209 A1
(43) Pub. Date: Jun. 5, 2025

(54) SYSTEM AND METHOD FOR VALUING STOCKS

(71) Applicant: Roderick Dillon, Naples, FL (US)

(72) Inventor: Roderick Dillon, Naples, FL (US)

(21) Appl. No.: 18/827,986

(22) Filed: Sep. 9, 2024

Related U.S. Application Data
(63) Continuation of application No. 17/714,799, filed on Apr. 6, 2022, now abandoned.
Application No. 17/714,799 is a continuation of application No. 16/509,345, filed on Jul. 11, 2019, now abandoned.
Application No. 16/509,345 is a continuation of application No. 15/444,023, filed on Feb. 27, 2017, now abandoned.
Application No. 15/444,023 is a continuation of application No. 14/636,146, filed on Mar. 2, 2015, now abandoned.
Application No. 14/636,146 is a continuation of application No. 11/666,983, filed on May 3, 2007, now abandoned.
(60) Provisional application No. 60/627,088, filed on Nov. 12, 2004.

(51) Int. Cl. G06Q 40/06; G06Q 30/02; G06Q 40/04; G06Q 40/08

(52) U.S. Cl. CPC G06Q 40/06; G06Q 30/0278; G06Q 40/04; G06Q 40/08

(57) ABSTRACT

A method for valuing stocks includes determining (510) a risk-adjusted present value of dividends for a stock over a predetermined holding period; and determining (520) a risk-adjusted present value of a price for the stock at the end of the predetermined holding period, the price for the stock at the end of the predetermined holding period being based at least on a tangible book value of the stock at the end of the predetermined holding period. The method further includes determining (530) an intrinsic value of the stock from the risk-adjusted present value of dividends for the stock over the predetermined holding period and the risk-adjusted present value of the price for the stock at the end of the predetermined holding period, and displaying (540)) the intrinsic value of the stock to a user.

### CROSS-REFERENCE TO RELATED APPLICATION

This application claims the benefit of U.S. Application No. 60/627,088 filed Nov. 12, 2004, which is incorporated herein by reference.

### TECHNICAL FIELD

The present invention relates to financial valuation methods. More specifically, the present invention relates to a method for valuing stocks.

### BACKGROUND OF THE INVENTION

One definition for the intrinsic value (i.e., IV) of a financial asset is that it is equal to the summation of the present value of cash flows associated with it. This is illustrated below:

$$IV = {\sum }_{t = 0}^{n} \frac{{CF}_{t}}{{( 1 + k )}^{t}} \qquad [ Eq . 1 ]$$

where Σ represents the summation from period “t=0” to period “t=n”, CF, represents the cash flows at time “t,” and k represents the risk-adjusted discount rate (e.g., the required return).

A general formula for stocks (e.g., the Gordon Model) may be expressed as follows:

$${IV}_{i} = \frac{{D}_{1}}{( {k}_{i} - {g}_{i} )} \qquad [ Eq . 2 ]$$

where IVᵢ represents the theoretical intrinsic value for stock “i”, Di represents the current indicated dividend, k; represents the risk-adjusted discount rate (e.g., the required return) and gᵢ represents the growth rate for stock “i”. This model is a special case of Eq. 1 that assumes constant growth of dividends into perpetuity.

There are many shortcomings to this model. For example, forecasting the future is difficult, and any attempt to go out into perpetuity, i.e., forever, is highly speculative. Equally apparent is the dependence on a current dividend. For companies where there is no current dividend, the Gordon Model calculates an intrinsic value of $0.

Furthermore, this model cannot calculate intrinsic value for companies with a growth rate (g) that exceeds the required return (k). In such cases, and where a current dividend exists, some investors will use a rearranged formula for the Gordon Model:

$$( \frac{{D}_{1}}{{P}_{0}} ) + {g}_{i} = {k}_{i}^{′} \qquad [ Eq . 2 a ]$$

where kᵢ′ is the estimated annual return, “P₀” is the current price and gᵢ is the estimated growth rate. Although this relationship lacks an explicit required return, it can be used to calculate a risk-adjusted excess return by subtracting an explicit required return from the estimated annual return. The risk-adjusted excess return is commonly referred to as “alpha.”

An alternative valuation technique that has become popular compares a stock's current price (“P”) divided by its current earnings per share (“E”) (thus P/E ratio, or simply “PE”), with its expected growth rate (“G”) of earnings over the next five years. This is sometimes called a PE to G, or “PEG” ratio. The idea is that the lower the ratio the better. The problem with the PEG ratio is that it simply provides an indication of relative valuation, but gives no indication of intrinsic value. Therefore, the PEG ratio does not provide a sufficient basis upon which to make appropriate investment decisions. Furthermore, because the PEG ratio does not explicitly consider risk, and required return, it is not useful for comparing stocks having different risk characteristics.

### SUMMARY OF THE INVENTION

In accordance with one of its principal aspects, the present invention provides a method which comprises (i.e., includes, but is not limited to) using a computer system to perform the following operations: determining a risk-adjusted present value of dividends for a stock over a predetermined holding period; determining a risk-adjusted present value of a price for the stock at the end of the predetermined holding period, the price for the stock at the end of the predetermined holding period being based at least on a tangible book value of the stock at the end of the predetermined holding period; determining an intrinsic value of the stock from the risk-adjusted present value of dividends for the stock over the predetermined holding period and the risk-adjusted present value of the price for the stock at the end of the predetermined holding period; and displaying the intrinsic value of the stock to a user of the computer system.

In accordance with another of its principal aspects, the present invention provides a machine-readable medium having stored thereon a plurality of executable instructions for performing a method which comprises determining a risk-adjusted present value of dividends for a stock over a predetermined holding period; determining a risk-adjusted present value of a price for the stock at the end of the predetermined holding period, the price for the stock at the end of the predetermined holding period being based at least on a tangible book value of the stock at the end of the predetermined holding period; determining an intrinsic value of the stock from the risk-adjusted present value of dividends for the stock over the predetermined holding period and the risk-adjusted present value of the price for the stock at the end of the predetermined holding period; and displaying the intrinsic value of the stock to a user of the computer system.

In accordance with yet another of its principal aspects, the present invention provides a system which comprises means for determining a risk-adjusted present value of dividends for a stock over a predetermined holding period; means for determining a risk-adjusted present value of a price for the stock at the end of the predetermined holding period, the price for the stock at the end of the predetermined holding period being based at least on a tangible book value at the end of the predetermined holding period; means for determining an intrinsic value of the stock from the risk-adjusted present value of dividends for the stock over the predetermined holding period and the risk-adjusted present value of the price for the stock at the end of the predetermined holding period; and means for displaying the intrinsic value of the stock to a user of the computer system.

In accordance with still another of its aspects, the present invention provides a system which comprises a network; and a valuation server component coupled to the network and including at least one processor, a memory coupled to the at least one processor, and a network interface coupled to the at least one processor and the network, the network interface adapted to enable communication between the at least one processor and one or more computing devices coupled to the network, and a computer program stored in the memory and adapted to determine an intrinsic value of a stock from a risk-adjusted present value of dividends for the stock over a predetermined holding period and a risk-adjusted present value of the price for the stock at the end of the predetermined holding period, in response to inputs from the one or more computing devices.

In accordance with yet another of its aspects, the present invention provides a system which comprises a network; and a valuation server component coupled to the network and including at least one processor, a memory coupled to the at least one processor, and a network interface coupled to the at least one processor and the network, the network interface adapted to enable communication between the at least one processor and one or more user computing devices coupled to the network, and a computer program stored in the memory and adapted to determine and output for a user an intrinsic value of a stock from a risk-adjusted present value of dividends for the stock over a predetermined holding period and a risk-adjusted present value of the price for the stock at the end of the predetermined holding period based at least in part on a tangible book value of the stock at the end of the predetermined holding period in response to inputs from the one or more computing devices.

In accordance with yet another of its aspects, the present invention provides a method of calculating a risk adjusted excess return, which comprises using a computer system to perform the following operations: solving P₀=

$${\sum }_{t = 1}^{n} [ \frac{{D}_{t}}{{( 1 + {k}_{i}^{′} )}^{t}} ] + \frac{{P}_{n}}{{( 1 + {k}_{i}^{′} )}^{n}}$$

for k′ᵢ, where P₀ is the present price of a stock i, n is a number of unit periods constituting a predetermined holding period, k′ᵢ is an estimate annual return, Dₜ are dividends received for unit period t, and Pₙ is the price of the stock at the end of the holding period and determined based at least on a tangible book value of the stock at the end of the predetermined holding period; subtracting a required return, kᵢ, from k′ᵢ and displaying the resulting risk adjusted excess return.

### BRIEF DESCRIPTION OF THE DRAWINGS

The aforementioned and other aspects of the present invention will be more fully appreciated from the detailed description hereinafter taken in conjunction with the accompanying drawings described briefly below.

FIG. 1 is a block diagram that illustrates a system architecture according to an embodiment of the present invention.

FIG. 2 illustrates a graphical interface for acquiring and displaying information according to an embodiment of the present invention.

FIG. 3 is a screen shot of the graphical interface of FIG. 2 showing a single company stock example according to an embodiment of the present invention.

FIG. 4 is a screen shot of the graphical interface of FIG. 2 showing a plurality of company stock examples according to an embodiment of the present invention.

FIG. 5 is a top-level flow diagram illustrating a method of operation of a stock valuation system according to an embodiment of the present invention.

FIG. 6 is a flow diagram illustrating a method of operation of a stock valuation system according to an embodiment of the present invention.

### DETAILED DESCRIPTION

Embodiments of the present invention include methodologies for valuing stocks derived from an understanding of the limitations of prior models combined with familiarity with both general economic theory and empirical evidence on which various components of such models and concepts are based. In one embodiment, the tangible book value per share, or “TBV,” is incorporated into the valuation. To the degree that accounting statements reflect economic reality, TBV may be thought of as an approximate liquidating value for a company. Arguably, if a company's prospects are estimated to be sufficiently negative, liquidation is a course of action to be considered by the board of directors. As such, the TBV may be a starting point for the valuation, with a second part being capitalized EPS, as will be appreciated from the discussion hereinafter.

Embodiments of the present invention utilize the current price of a stock as a dynamic variable. This is consistent with the notion that the current price contains valuable information regarding investors' opinions of future growth prospects and risk. This information may thus be embedded, for example, in the Price-to-Earnings (PE) ratio. One theory suggests that excess returns, otherwise allowing for growth, may be competed away over time, and empirical evidence suggests that this process may take place in as few as four years. Accordingly, a mean reversion is advantageously incorporated into the valuation.

Methods for determining an estimate of the intrinsic value (IV) of a stock and the alpha according to the present invention are presented below. For a share of common stock not held forever, the estimate of the intrinsic value is equal to the risk-adjusted present value of all the future cash flows, which includes both dividends and the proceeds received when the stock is ultimately sold. The risk-adjusted present value of all the future cash flows over a defined holding period is, essentially, a dividend discount model. The challenge for the security analyst is estimating these future cash flows, as well as the return required as compensation for the risk of the stock. An embodiment of the present invention assumes that the current dividend and earnings grow at some rate during the holding period and that the stock is ultimately sold for the sum of TBV plus some multiple of the earnings at the end of the holding period. A required return k is estimated, such as one derived from the use of some conventional method (e.g., the Capital Asset Pricing Model), and, if a period of five years is selected, the intrinsic value IV for stock “i” may be written as follows:

$${IV}_{i} = {\sum }_{t = 1}^{5} [ \frac{{D}_{t}}{{( 1 + {k}_{i} )}^{t}} ] + \frac{{P}_{5}}{{( 1 + {k}_{i} )}^{5}} \qquad [ Eq . 3 ]$$

where Dₜ are dividends received at time “t” over the five year period and P_{S} represents the price of the stock at the end of year 5, which is calculated in accordance with Equation 4 below. For the calculation of Equation 4, TBV_{S} is determined by adding estimated retained earnings per share (earnings per share minus dividends per share), over the five year period, to the initial TBV (“TBV₀”). EPS_{S} is determined by growing current earnings at an annualized rate for five years. For cyclical companies, a normalization of earnings may be preferred. EPS_{S} is then multiplied by an adjusted terminal Price-to-Earnings ratio (“Adjusted PE_{S}” explained below), calculated for year 5, and added to TBV_{S}, so that:

$${P}_{5} = {TBV}_{5} + ( Adjusted {PE}_{5} ) ( {EPS}_{5} ) \qquad [ Eq . 4 ]$$

Embodiments of the present invention advantageously incorporate the concept of mean reversion in PE ratios in order to arrive at an adjusted terminal PE ratio, and thus an estimate for P₅. The preferred embodiment assumes that the current adjusted PE (Adjusted PE₀) will revert halfway toward a terminal market adjusted PE in five years. The adjusted PE is defined as the stock price minus the TBV, divided by EPS (which may preferably be normalized). For example, if P₀ is $30, TBV₀ is $10, EPS, is $1.25 (such that ($30−$10)/1.25 equals an Adjusted PE₀ of 16), and the estimated terminal market PE is 10, then the adjusted terminal PE value (Adjusted PE₅) is 13 (i.e., 16+10 divided by 2). The use of normalized EPS is often advantageous to remove or smooth out the effects of cyclicality and one-time accounting charges. Normalization may be performed in various ways. In a preferred approach, a trend line is first determined using linear regression. The data points for the regression are, for example, the past 20 quarters of reported EPS and the next four quarters estimated EPS, for a total of 24 data points. From the trend line, the past two quarters and next two quarters are extracted, resulting in normalized EPS.

Embodiments of the present invention also solve for kᵢ′ by substituting P₀ for IVᵢ in Equation 3, where kᵢ′ is an estimated annual return:

$${P}_{0} = {\sum }_{t = 1}^{5} [ \frac{{D}_{t}}{{( 1 + {k}_{i}^{′} )}^{t}} ] + \frac{{P}_{5}}{{( 1 + {k}_{i}^{′} )}^{5}} \qquad [ Eq . 3 a ]$$

This approach can be used to calculate a risk-adjusted excess return by subtracting an explicit required return (kᵢ) from the estimated annual return (k′ᵢ), resulting in risk-adjusted excess return, i.e., alpha (a), which may be expressed in equation form as: α=kᵢ′−kᵢ.

It will be appreciated, of course, that embodiments of the present invention are not limited to a holding period of five years. Equations 3, 3a, and 4 can thus be represented as Equations 5, 5a and 6, respectively, for a generalized holding period of “n” unit periods (e.g., years):

$${IV}_{i} = {\sum }_{t = 1}^{n} [ \frac{{D}_{t}}{{( 1 + {k}_{i} )}^{t}} ] + \frac{{P}_{n}}{{( 1 + {k}_{i} )}^{n}} \qquad [ Eq . 5 ]$$

$${P}_{0} = {\sum }_{t = 1}^{n} [ \frac{{D}_{t}}{{( 1 + {k}_{i}^{′} )}^{t}} ] + \frac{{P}_{n}}{{( 1 + {k}_{i}^{′} )}^{n}} \qquad [ Eq . 5 a ]$$

$${P}_{n} = {TBV}_{n} + ( Adjusted {PE}_{n} ) ( {EPS}_{n} ) \qquad [ Eq . 6 ]$$

Preferably “n” would be chosen in correspondence with the period required for PE mean reversion in a particular industry of interest.

Embodiments of the present invention provide a flexible framework in which to value a stock. Different macro-economic outlooks may be advantageously accommodated by exploring the interplay between earnings, the expected growth rate of those earnings, the risk-adjusted discount rate and estimates of the adjusted terminal market P/E. For example, the flexibility to overlay individual judgment regarding such issues as translating accounting earnings into economic earnings, incorporating recent developments, factoring in qualitative information, etc., leads each analyst to an informed conclusion. Moreover, given the possibility for imprecision in these judgments, the ability to investigate various scenarios advantageously provides insight into the relationships between assumed values, such as, for example, the sensitivity of the calculated intrinsic value to the various estimates, etc.

Table A summarizes various exemplary data used to compare the intrinsic value of a stock, determined by an embodiment of the present invention, to other methods.

TABLE A

| | Companies | | |
|---|---|---|---|
| Parameter | BMY | MRK | PFE |
| Current Price (P₀) | $ 24.33 | $ 44.57 | $ 35.02 |
| Tangible Book Value | $ 1.68 | $ 6.23 | $ 0.88 |
| (TBV₀) | | | |
| Current EPS (EPS₀) | $ 1.57 | $ 2.42 | $ 2.23 |
| PE Ratio (PE₀) | 15.5 | 18.4 | 15.7 |
| Adjusted PE Ratio | 14.4 | 15.8 | 15.3 |
| (Adjusted PE₀ = (P₀ − | | | |
| TBV₀)/EPS₀) | | | |
| Current Dividend | $ 1.12 | $ 1.48 | $ 0.68 |
| Required Return kᵢ | 9.0% | 7.0% | 8.0% |
| Estimated Growth | 6.0% | 4.0% | 13.0% |

Where, in the adjusted PE Ratio, the adjusted terminal market PE assumption is 12.

Table B presents an analysis obtained using the Gordon model and Equation 2a.

TABLE B

| | Companies | | |
|---|---|---|---|
| Parameter | BMY | MRK | PFE |
| kᵢ′ | 10.6% | 7.3% | 14.9% |
| Required Return kᵢ | 9.0% | 7.0% | 8.0% |
| Alpha | 1.6% | 0.3% | 6.9% |

The assumption of constant growth results in a wide variance of estimated returns and alphas, with PFE easily the most attractive, given the calculated alphas (risk-adjusted excess return).

Table C presents an analysis obtained using Equations 3a and 4 of the present invention.

TABLE C

| | Companies | | |
|---|---|---|---|
| Parameter | BMY | MRK | PFE |
| TBV₅ | $ 2.29 | $ 7.37 | $ 3.74 |
| EPS₅ | $ 2.10 | $ 2.94 | $ 4.11 |
| Adjusted PE₅ | 13.2 | 13.9 | 13.7 |
| P₅ | $ 30.05 | $ 48.36 | $ 59.84 |
| Annualized Price | 4.3% | 1.6% | 11.3% |
| Appreciation | | | |
| Annualized Dividend | 4.6% | 3.3% | 1.9% |
| Return | | | |
| Annual Return kᵢ′ | 8.9% | 4.9% | 13.2% |
| Required Return kᵢ | 9.0% | 7.0% | 8.0% |
| Alpha | −0.1% | −2.1% | 5.2% |

These results suggest that PFE is the most attractive, and the lower estimated annual returns and alphas (compared to Gordon Model) are more reasonable given some level of market efficiency, with which most academics and practitioners would agree.

Table D presents an analysis obtained using the PEG model.

TABLE D

| | Companies | | |
|---|---|---|---|
| Parameter | BMY | MRK | PFE |
| PE/G | 2.6 | 4.6 | 1.2 |

This relative valuation tool suggests that PFE is most attractive stock, with BMY considerably more attractive than MRK.

Table E presents an analysis obtained using Equations 3 and 4 of the present invention.

TABLE E

| | Companies | | |
|---|---|---|---|
| Parameter | BMY | MRK | PFE |
| IV | $ 24.91 | $ 41.52 | $ 44.78 |
| Current Price/IV | 0.98 | 1.07 | 0.78 |

With the lower ratio of (Current Price/IV) preferable, PFE is considered more attractive, which is consistent with the alpha calculation.

This example demonstrates how different growth rates and required returns yield a different magnitude of results for the PEG ratio and the method of the current invention. Analogously, the two methodologies would yield different results given companies with similar growth rates but dissimilar required returns.

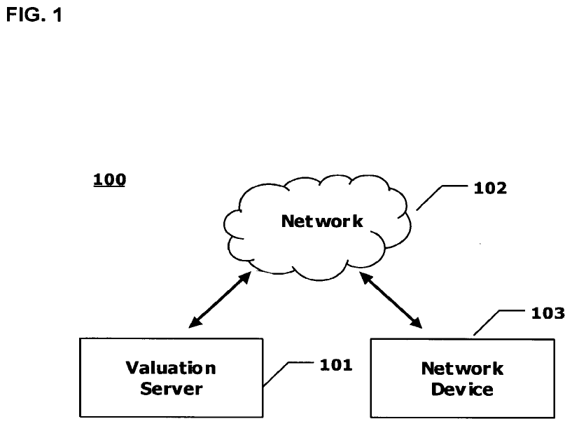

FIG. 1 is a block diagram that illustrates a system architecture according to an embodiment of the present invention. System 100 includes valuation server 101 coupled to network 102 and at least one network computing device 103 coupled to network 102. Valuation server 101 includes hardware and software adapted to perform methods associated with various embodiments of the present invention, such as, one or more processors, memory, network interfaces, etc. Network computing device 103 includes hardware and software for acquiring and displaying information associated with various embodiments of the present invention, such as a web browser, processor, memory, network interface, keyboard, mouse, etc.

In one embodiment, valuation server 101 may include hardware and software for acquiring and displaying information, while in another embodiment, network computing device 103 may include hardware and software adapted to perform methods associated with various embodiments of the present invention. Network 102 may be a wired or wireless network, an intranetwork or internetwork, the Internet, etc. Valuation server 101 and network computing device 103 may acquire information, over network 102, from other resources (not shown).

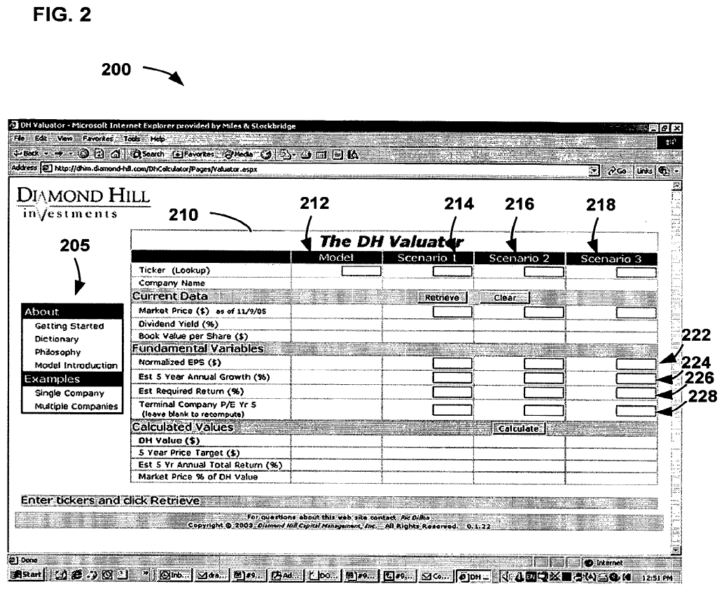

FIG. 2 is a screen shot of a graphical interface 200 in a computer program implementing a valuation model for acquiring and displaying information according to an embodiment of the present invention. Graphical interface 200, for example, a graphical user interface, allows a user to adjust parameters of the valuation model to enable calculation (according to the principles discussed herein) of different scenarios for a particular stock, thus permitting comparison of various scenarios of interest. Graphical interface 200 may include an option box 205 in which information about the valuation model may be accessed and a valuation section 210. Valuation section 210 may include, for example, a “Model” scenario valuation column 212, for which data may be automatically furnished via the valuation server 101, and the user may then adjust selected parameters to create additional scenarios for comparison. For example, the parameters that may be adjusted may include, but are not limited to, one or more normalized EPS (earnings per share) values 222, one or more estimated 5-year annual growth percentages 224, one or more estimated required return percentages 226, and one or more terminal company price-to-earnings values 228 for year 5. Of course, graphical interface 200 may be adapted to show “Model” scenarios for a plurality of stocks, with or without the option for alternative scenarios, as desired.

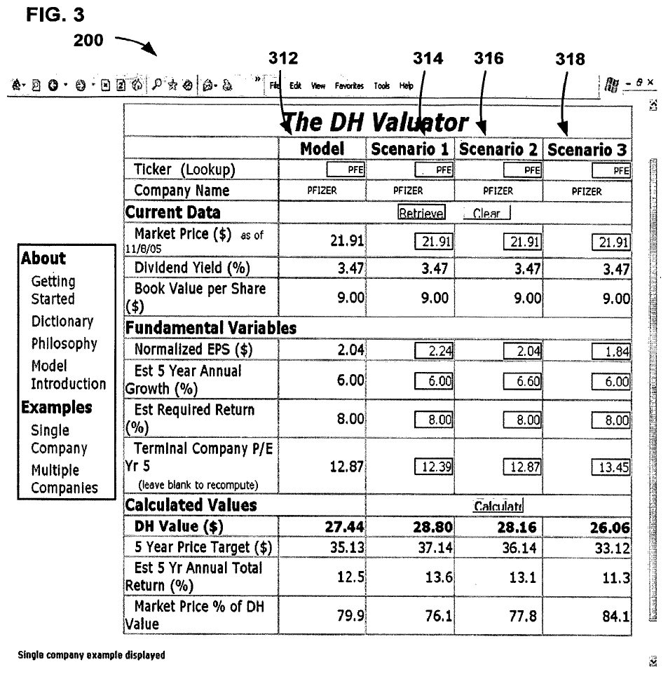

FIG. 3 is a screen shot of the graphical interface 200 of FIG. 2 showing valuation of a single company stock, Pfizer (Symbol: PFE), according to an embodiment of the present invention. Graphical interface 200 shows valuation results in a model column 312 and three alternative scenario valuation results in a scenario 1 column 314, a scenario 2 column 316, and a scenario 3 column 318.

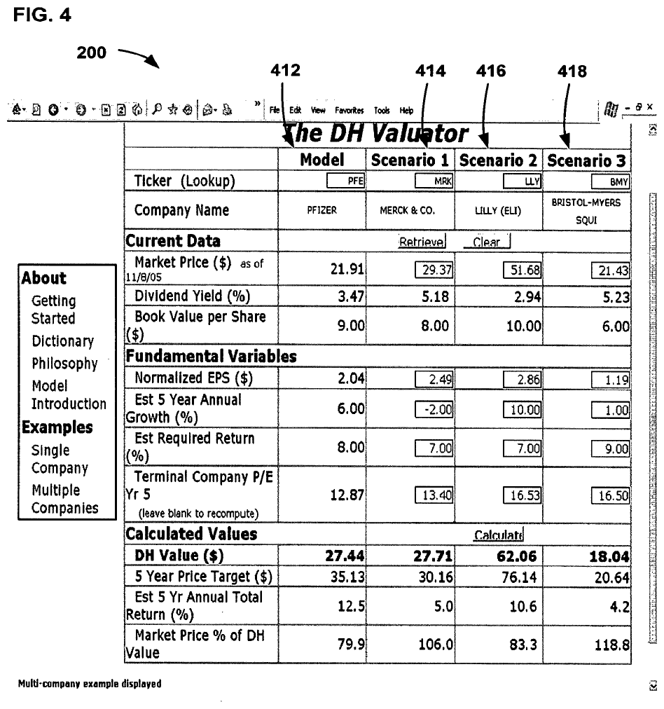

FIG. 4 is a screen shot of the graphical interface 200 of FIG. 2 showing valuation of a plurality of company stocks, according to an embodiment of the present invention. Graphical interface 200 shows valuation results for Pfizer (Symbol: PFE) in a model column 412 and three alternative scenario valuation results for three different stocks. For example, valuation results for Merck & Co. (Symbol: MRK) in a scenario 1 column 414, valuation results for Lilly (Eli) (symbol: LLY) in a scenario 2 column 416, and valuation results for Bristol-Myers Squib (Symbol: BMY) in a scenario 3 column 418.

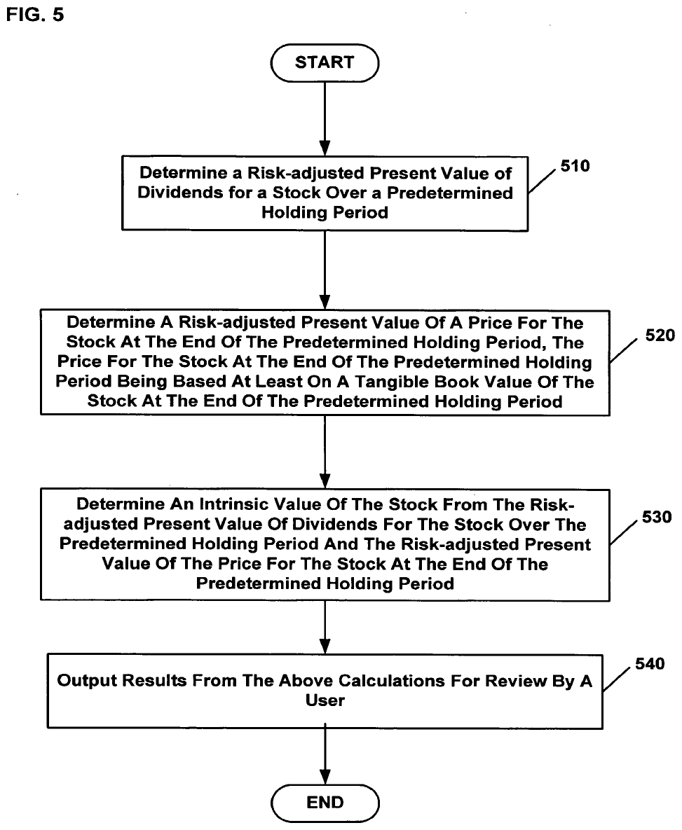

FIG. 5 is a top-level flow diagram illustrating a method of operation of a stock valuation system according to an embodiment of the present invention. In FIG. 5, the method may include determining (510) a risk-adjusted present value of dividends for a stock over a predetermined holding period; and determining (520) a risk-adjusted present value of a price for the stock at the end of the predetermined holding period, the price for the stock at the end of the predetermined holding period being based at least on a tangible book value of the stock at the end of the predetermined holding period. The method may further include determining (530) an intrinsic value of the stock from the risk-adjusted present value of dividends for the stock over the predetermined holding period and the risk-adjusted present value of the price for the stock at the end of the predetermined holding period. The method may still further include displaying (540) the intrinsic value of the stock to a user of the method. The method may be performed manually and/or with the use of a computer and computer program that is adapted to perform the above-described operations.

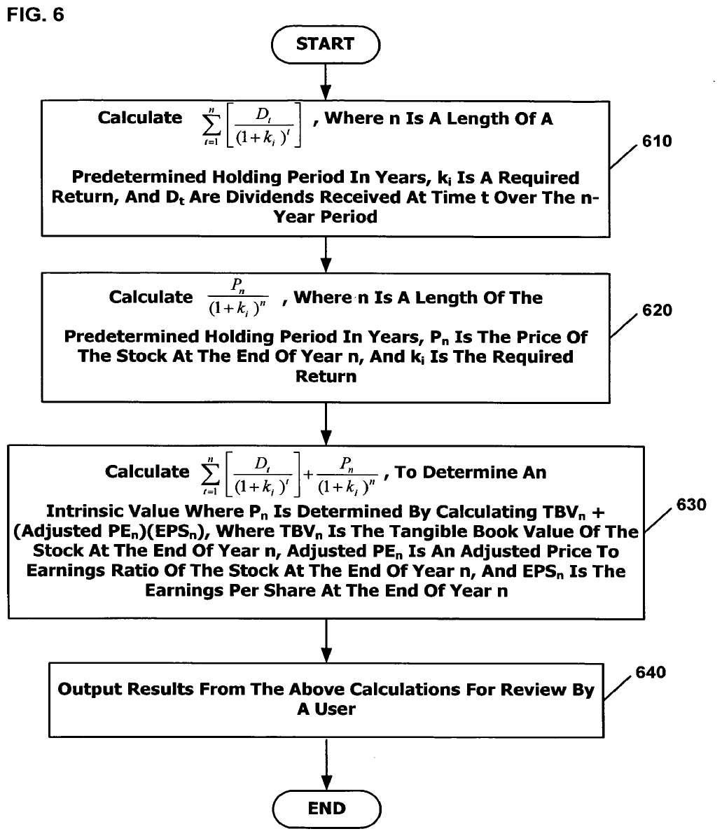

FIG. 6 is a detailed flow diagram illustrating a method of operation of a stock valuation system according to an embodiment of the present invention wherein the unit period is one year. In FIG. 6, the method includes calculating (610)

$${\sum }_{t = 1}^{n} [ \frac{{D}_{t}}{{( 1 + {k}_{i} )}^{t}} ] ,$$

where n is a length of the predetermined holding period in years, kᵢ is a required return for a stock i, and Dₜ are dividends received for stock i for year t in the n-year period. The method further includes calculating (620)

$$\frac{{P}_{n}}{{( 1 + {k}_{i} )}^{n}} ,$$

where Pₙ is the price of stock i at the end of year n, and n and kᵢ are as described above. Pₙ is determined by calculating TBVₙ+(Adjusted PEₙ)(EPSₙ), where TBV, is the tangible book value of stock i at the end of year n, Adjusted PEₙ is an adjusted price-to-earnings ratio of stock i at the end of year n, and EPSₙ is the earnings per share of stock i at the end of year n, all as previously discussed. The method also includes calculating (630)

$${\sum }_{t = 1}^{n} [ \frac{{D}_{t}}{{( 1 + {k}_{i} )}^{t}} ] + \frac{{P}_{n}}{{( 1 + {k}_{i} )}^{n}}$$

to obtain an intrinsic value for stock i. The method still further includes outputting (640) results from the above operations for review by a user of the method.

While this invention has been described in conjunction with specific embodiments, it is to be understood that these embodiments are intended to be illustrative and not limiting. Various changes may be made without departing from the spirit and principles of the invention as set forth herein.

1-29. (canceled)

30. Apparatus comprising:
a computer system configured to determine an intrinsic value of a stock from a risk-adjusted present value of dividends for the stock over a predetermined holding period and a risk-adjusted present value of a price for the stock at an end of the predetermined holding period, and to display the intrinsic value of the stock to a user of the computer system,
wherein the computer system includes:
a programmed processor, the processor executing a program that causes the processor to calculate
$${\sum }_{t = 1}^{n} [ \frac{{D}_{t}}{{( 1 + {k}_{i} )}^{t}} ] + \frac{{P}_{n}}{{( 1 + {k}_{i} )}^{n}} ,$$
where n is a number of unit periods constituting the holding period, kᵢ is a required return for stock i, Dₜ are dividends received for stock i for unit period t, and Pₙ is the price of stock i at the end of the holding period,
wherein the program further causes the processor to determine Pₙ by calculating TBVₙ+(Adjusted PEₙ)(EPSₙ), where TBVₙ is a tangible book value of stock i at the end of the holding period, Adjusted PEₙ is an adjusted price-to-earnings ratio of stock i at the end of the holding period, and EPSₙ is the earnings per share of stock i at the end of the holding period, and
wherein Adjusted PEₙ is halfway between an initial price-to-earnings ratio of stock i and a terminal market price-to-earnings ratio for stock i at the end of the holding period.

31. A system comprising:
a network; and
a valuation server component coupled to the network and including at least one processor, a memory coupled to the at least one processor, and a network interface coupled to the at least one processor and the network, the network interface adapted to enable communication between the at least one processor and one or more user computing devices coupled to the network, and a computer program stored in the memory and adapted to cause the at least one processor, when executing the computer program, to determine and output for a user an intrinsic value of a stock from a risk-adjusted present value of dividends for the stock over a predetermined holding period and a risk-adjusted present value of the price for the stock at the end of the predetermined holding period based at least in part on a tangible book value of the stock at the end of the predetermined holding period, in response to inputs from the one or more user computing devices,
wherein the computer program further causes the determination of intrinsic value of the stock from the risk-adjusted present value of dividends for the stock over the predetermined holding period and the risk-adjusted present value of the price for the stock at the end of the predetermined holding period to include:
calculating
$${\sum }_{t = 1}^{n} [ \frac{{D}_{t}}{{( 1 + {k}_{i} )}^{t}} ] + \frac{{P}_{n}}{{( 1 + {k}_{i} )}^{n}} ,$$
where n is a number of unit periods constituting the holding period, kᵢ is a required return for stock i, Dₜ are dividends received for stock i for unit period t, and Pₙ is the price for stock i at the end of the holding period,
wherein Pₙ is determined by calculating TBVₙ+(Adjusted PEₙ) (EPSₙ), where TBVₙ is a tangible book value of stock i at the end of the holding period, Adjusted PEₙ is an adjusted price-to-earnings ratio of stock i at the end of the holding period, and EPSₙ is the earnings per share of stock i at the end of the holding period, and
wherein Adjusted PEₙ is halfway between an initial price-to-earnings ratio of stock i and a terminal market price-to-earnings ratio at the end of the holding period.
